(19) United States
(12) Patent Application Publication
(10) Pub. No.: US 2016/0330911 A1
(43) Pub. Date: Nov. 17, 2016

(54) COMPRESSED BALE PACKAGING APPARATUS WITH CROWNED DISCHARGE MANDREL

(71) Applicant: Signode Industrial Group LLC, Glenview, IL (US)

(72) Inventors: Joseph E. Lininger, Union Grove, WI (US); Timothy B. Pearson, Antioch, IL (US); Andrew J. Nyckowski, Beach Park, IL (US)

(21) Appl. No.: 15/088,380

(22) Filed: Apr. 1, 2016

Related U.S. Application Data
(60) Provisional application No. 62/161,586, filed on May 14, 2015.

(51) Int. Cl. A01F 25/14; B65B 35/10

(52) U.S. Cl. CPC A01F 25/14; B65B 35/10

(57) ABSTRACT

A system for transferring and containing a bale of compressible material includes a conveyor, a transfer device to transfer the bale of compressible material from the conveyor and a bagger. The bagger includes an entrance, a discharge station and a bag mandrel. The bale is received in the entrance from the transfer device and is discharged from the bagger by the discharge station into a bag positioned on the mandrel. The mandrel has a plurality of walls, at least one of the walls having a crowned profile.

CROSS-REFERENCE TO RELATED APPLICATION DATA

This application claims the benefit of and priority to Provisional U.S. Patent Application Ser. No. 62/161,586, filed May 14, 2015, the disclosure of which is incorporated herein in its entirety.

### BACKGROUND

Large quantities of low density fibrous materials such as cotton and the like are often bundled or baled for handling and storage. In a typical process, cotton is cleaned to separate the cotton fibers from sticks and other debris, and the cotton fibers are separated from the seed in a gin. The cotton (referred to as lint) is transported to a press or baler where it is compressed into a high density bundle or bale. Following compaction, the bale is secured to facilitate handling. The bale can be secured by multiple straps or wires to maintain the bale configuration and stability. One industry standard is to band the bale with eight (8) wires or straps around the shorter periphery of the bale.

Typically, the bale is then sampled and classed into a standard cotton class to identify the quality of the cotton. The bale is then wrapped for protection, for example, in a wrap or bag, to protect the cotton from exposure to the environs, dirt, debris or factors that can affect the cotton quality. Wrapping or bag materials include polyethylene, polypropylene, cotton and the like. The wrapped bale can then be transported for subsequent processing.

While the wrapping or bagging can help to prevent damage to the bale, the wrapping or bagging material itself can be damaged. For example, at ginning facilities, cotton bales are often stored two layers high, which can put a significant amount of strain on the bales, particularly the bottom bale. Also, the cotton bales stored in certain facilities have to be rearranged or moved from time to time, such as while being loaded onto a truck for delivery. Moreover, the configuration of cotton bales being stored in a warehouse or other storage facility has to be changed from time to time in order to optimize warehouse space. During this stacking and moving, and loading and unloading of the bales described above, the bales are frequently being pushed on an abrasive surface (e.g., concrete or asphalt flooring of a warehouse or storage facility) causing straps to break and bags or wrapping material to rupture.

U.S. Publication No. 2014/0158560 to Nyckowski et al. discloses a method and apparatus for containing a bale of compressible material. The Nyckowski et al. publication discloses a press in which grooves are formed in the bale by upper and/or lower plates or platens in a direction transverse to the direction of compression of the material. The grooves facilitate handling of the bale.

The device disclosed in Nyckowski includes a press, a bagger and a transfer device to move the compressed bale from the press to the bagger. The bagger includes a mandrel on a discharge thereof. A bag is positioned on the mandrel and the compressed bale is urged from the bagger, through the mandrel and into the bag. The mandrel includes straight sides and a downward taper to facilitate moving the bale into the bag.

An issue that has been observed with strapless baling is that the bale tends to expand after compression and prior to inserting or positioning the bale in a bag. As such, the extent of expansion of the bale must be considered in the downstream packaging, e.g., the transfer and bagging, equipment so that bale can be readily and efficiently packaged. The known mandrel configuration, which includes straight sides and a downwardly tapered or ramped top wall, increases the back pressure on the bale and thus the force needed to move the bale through the bagger and into the bag, especially as expansion of the bale may occur throughout the process.

There is therefore a need for an improved system for baling a highly compressible material, such as cotton, in a manner that can contain the pressure of the highly compressed material, that maintains the integrity of the bale and that facilitates handling and movement of the compressed bale through downstream equipment.

### SUMMARY

Various embodiments of the present disclosure provide a system and method and/or device for containing a bale of compressible material without the use of straps or wires. The bale is compressed in a press and introduced into a bag. The bale is compressed in a press that includes a bale box having stationary sidewalls and one or more moving compression plates. The bale is compressed in such a manner that channels or grooves are formed in sides of the bale. The grooves can be formed by the stationary sidewalls, the compression plates or both. As described in further detail below, as the compressed bale is moved through downstream equipment from the press to a bagger and into the bag, it expands.

In an embodiment, a system for transferring and containing the bale includes a conveyor to convey the bale from the press to the bagger, a transfer device to transfer the bale from the conveyor and a bagger. The bagger has an entrance, a discharge station and a bag mandrel. The bale is received in the entrance from the transfer device and is discharged from the bagger by the discharge station into a bag positioned on the mandrel. The mandrel has a plurality of walls at least two of which have a crowned profile.

In an embodiment, the mandrel includes four wall. The crowned walls can be upper and lower or top and bottom walls. The side walls between the top and bottom walls can be planar. The crowned profile can be formed by a substantially constant radius in the top and bottom walls. In this configuration, a cross-sectional area of the mandrel is substantially constant along a length thereof. A distance measured at a peak-to-peak location of the crowned profile between the top and bottom walls can be at least about 108 percent of a height of the side walls. The crowned wall or walls relieves back pressure as the bale is moved through the mandrel and into the bag.

In an embodiment, a bag mandrel for use on a device for compressing and containing a bale of compressible material includes four walls defining an open discharge region for conveyance of the bale. Two of the walls opposing one another have a crowned profile. The walls extending between the crowned profile walls can be planar.

A method for transferring and containing a bale of compressible material includes transferring the bale of compressible material to an entrance of a bagger, moving the bale of compressible from the entrance to a mandrel that has at least two walls having a crowned profile so as to define an air space between the bale of compressible material and the at least two walls and urging the bale of compressible material out of the mandrel and into a bag positioned on an end of the mandrel. The air space between the bale of compressible material and the at least two walls has an arcuate profile.

These and other features and advantages of the present method, system and device will be apparent from the following detailed description, in conjunction with the appended claims.

### BRIEF DESCRIPTION OF THE DRAWINGS

FIG. 1 is a perspective illustration of an example embodiment of a compressible material press and a baler including an example embodiment of a system of the present disclosure, which includes a compressible material press, a conveyor and a bagging station or bagger;

FIG. 2 is a top view of the baler and press of FIG. 1;

FIG. 3 is a perspective view of a conveyor load carriage and a mobile base of the illustrated example embodiment of the system of the present disclosure;

FIG. 4 is a front view of the conveyor load carriage and mobile base;

FIG. 5 is a side view of the conveyor load carriage and mobile base;

FIG. 6 is perspective view of the conveyor load carriage and mobile base in position to transfer a bale to a bagger;

FIG. 7 illustrates the load carriage and base showing the transfer plate in an extended state;

FIG. 8 illustrates the load carriage in a partially pivoted state with the transfer plate extended;

FIG. 9 is another illustration of the load carriage in a partially pivoted state;

FIG. 10 is perspective illustration of the bagger entrance and showing, in partial view, the discharge drive;

FIG. 11 is an illustration looking into the discharge end of the bagger and showing the discharge drive plate;

FIG. 12 is a view looking into the entrance of the bagger and showing the back-up plate;

FIG. 13 is a side view of the bagger and the back-up cylinders;

FIG. 14 is a perspective view of the bale press and a bale with the gate in an open position;

FIG. 15 is a perspective view of an example bag for containing a compressed bale of material in accordance with an embodiment of the system of the present disclosure, where the bag is shown in a folded state;

FIG. 16 is a front view of the example bag;

FIG. 17 is a side view of the example bag in a folded state;

FIGS. 18a-18c illustrate three different example bag weave densities;

FIG. 19 is a front view of the example bag which shows the relationship of the compressed bale and the grooves or recesses formed in the bale from compression (and the load carriage fork set engaging the bale) and the bag as it conforms to the grooves in the bale;

FIG. 20 is a top view of the bale in the load carriage as illustrated in FIG. 19;

FIG. 21 is a perspective view of the compressed bale in the load carriage fork set;

FIG. 22 is an exploded illustration of a compressed bale and an embodiment of a bale box;

FIG. 23 is a top view of an example of a bale box showing internal ribs for forming grooves in the compressed bale;

FIG. 24 is a perspective view of a bale compressed in the bale box of FIGS. 22 and 23; and

FIG. 25 is a perspective illustration of a known bagging mandrel;

FIG. 26 is a perspective view of an embodiment of a crowned bagging mandrel; and

FIG. 27 is a front view of the crowned bagging mandrel of FIG.

26.

### DETAILED DESCRIPTION

Various embodiments of the present disclosure provide a method, system, and/or device for containing a bale of compressible material without the use of straps or wires.

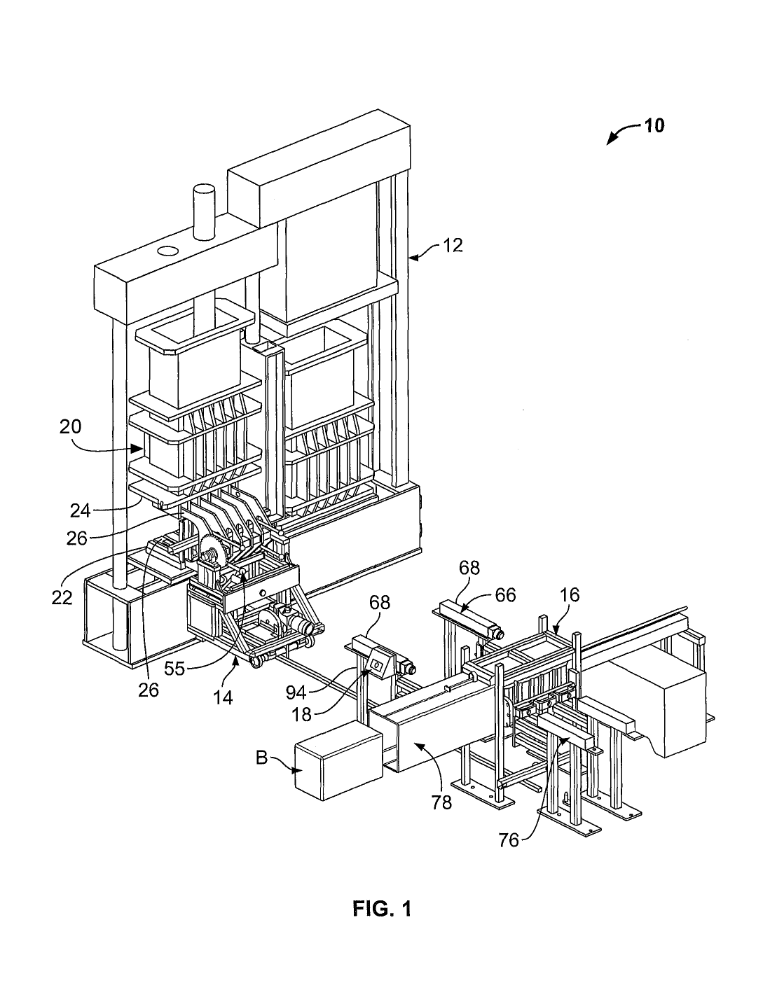

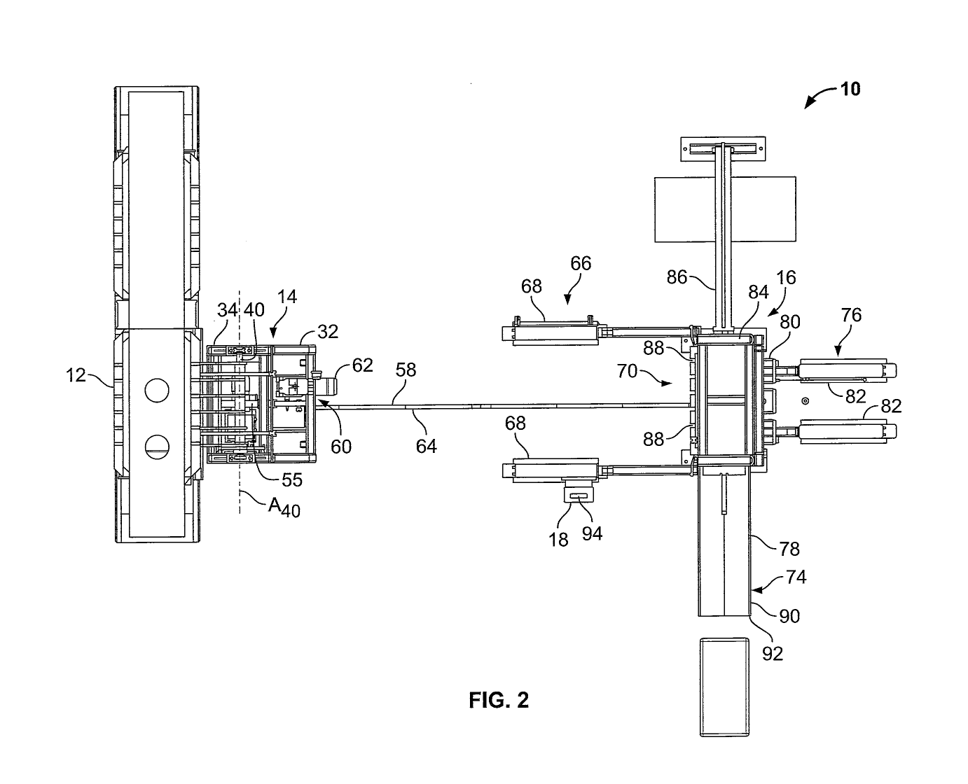

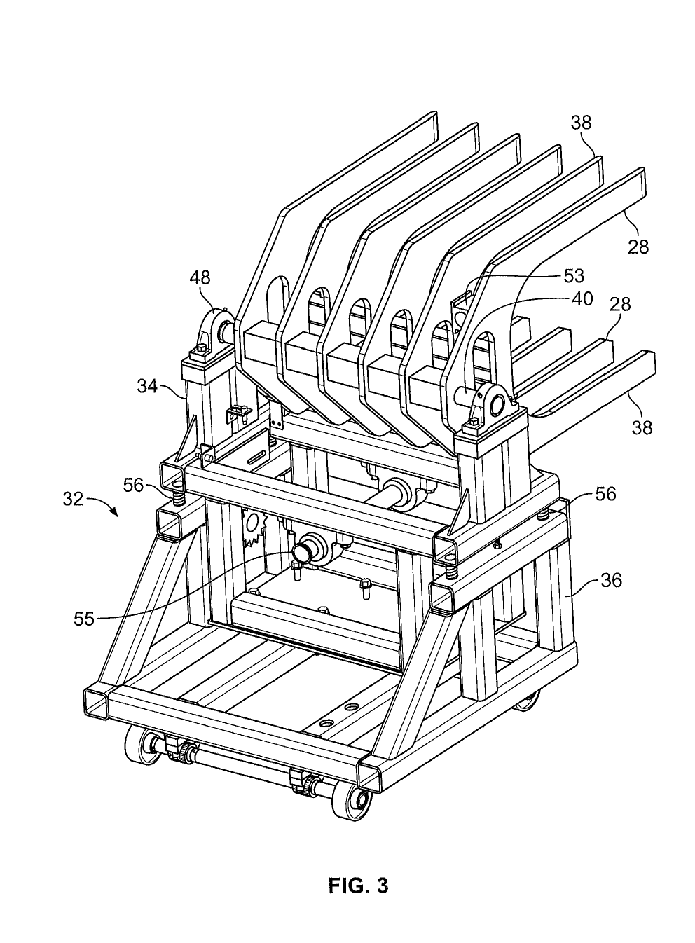

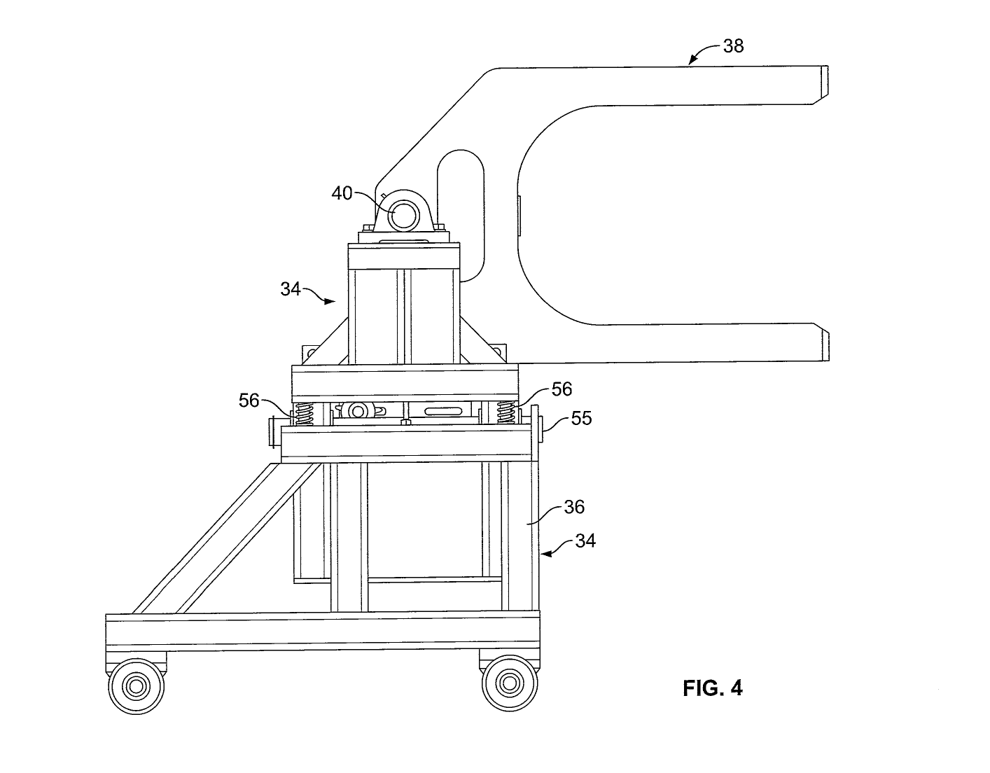

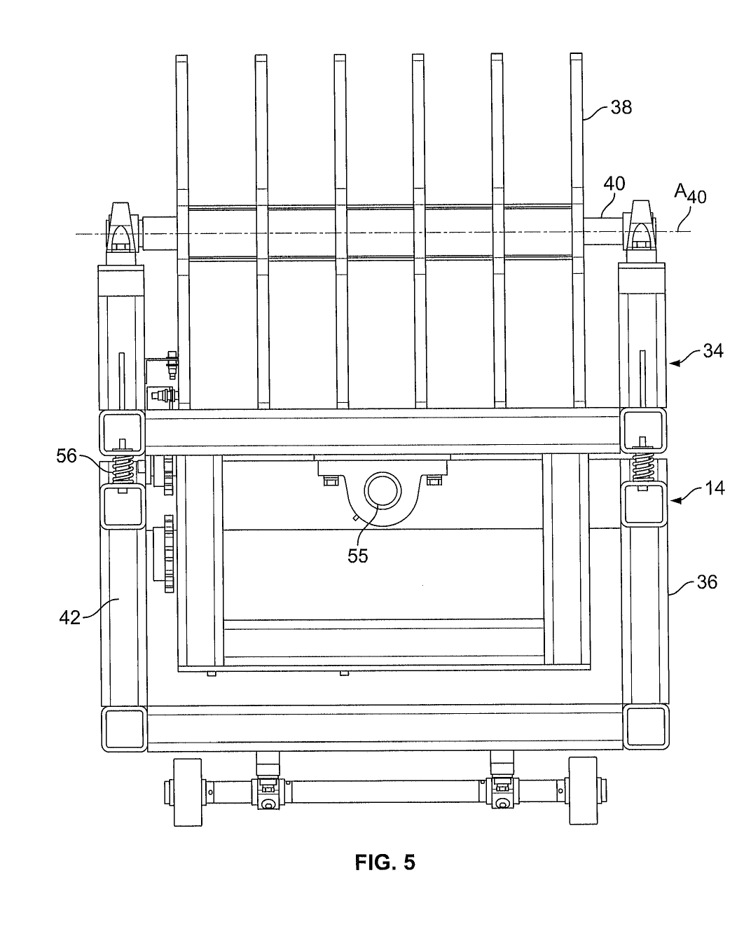

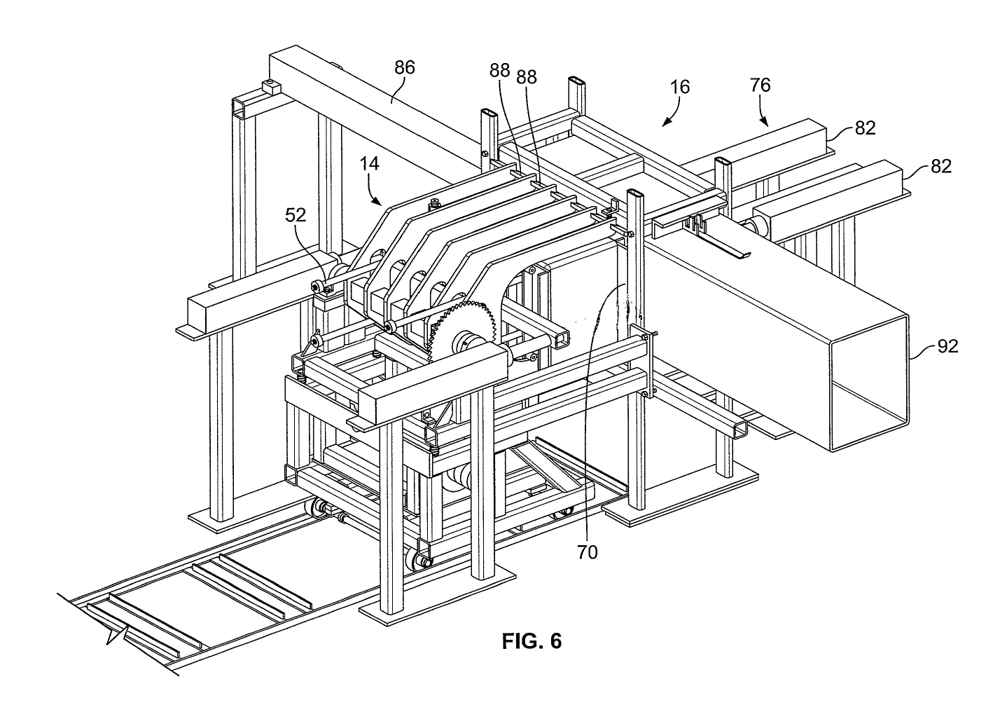

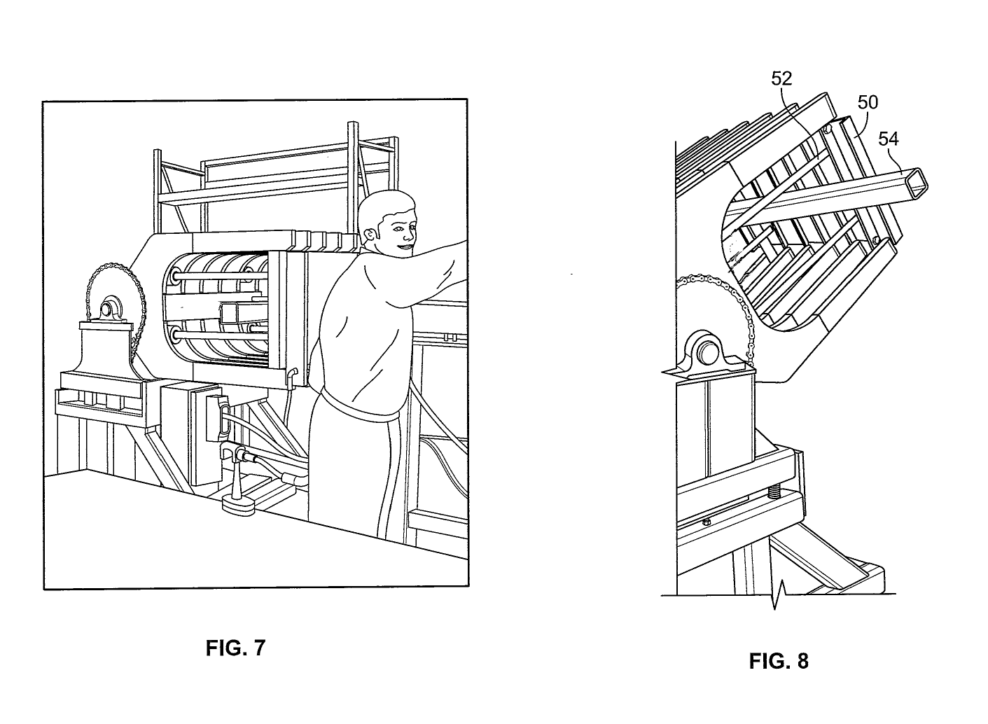

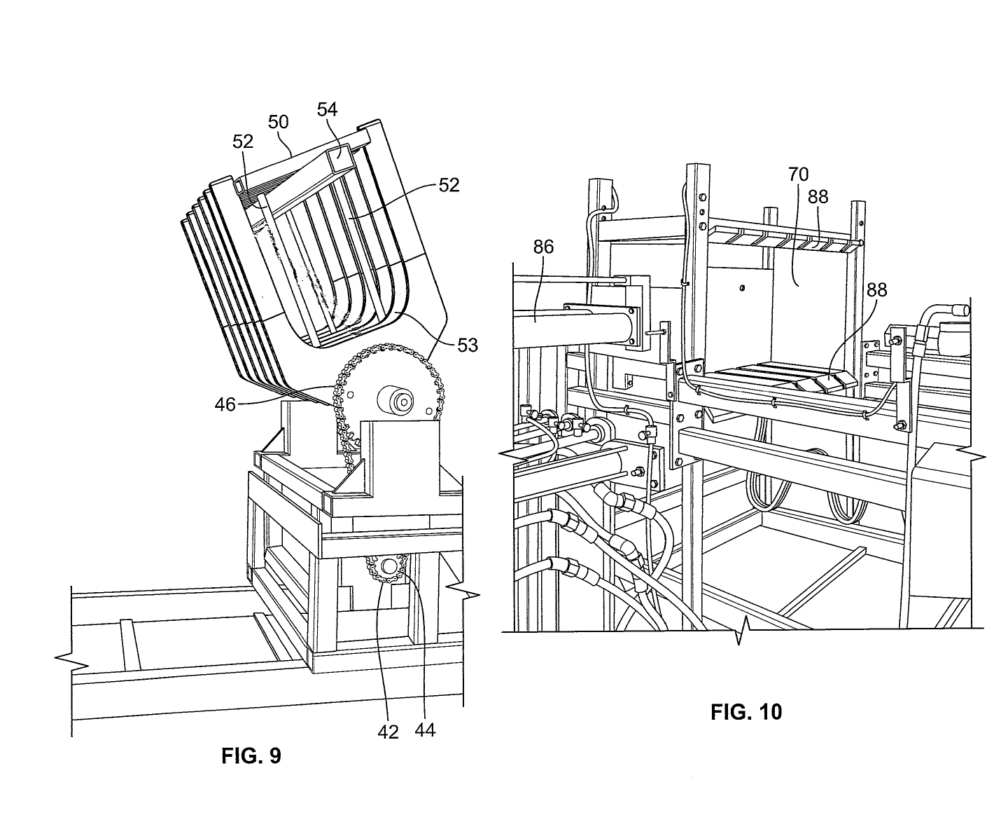

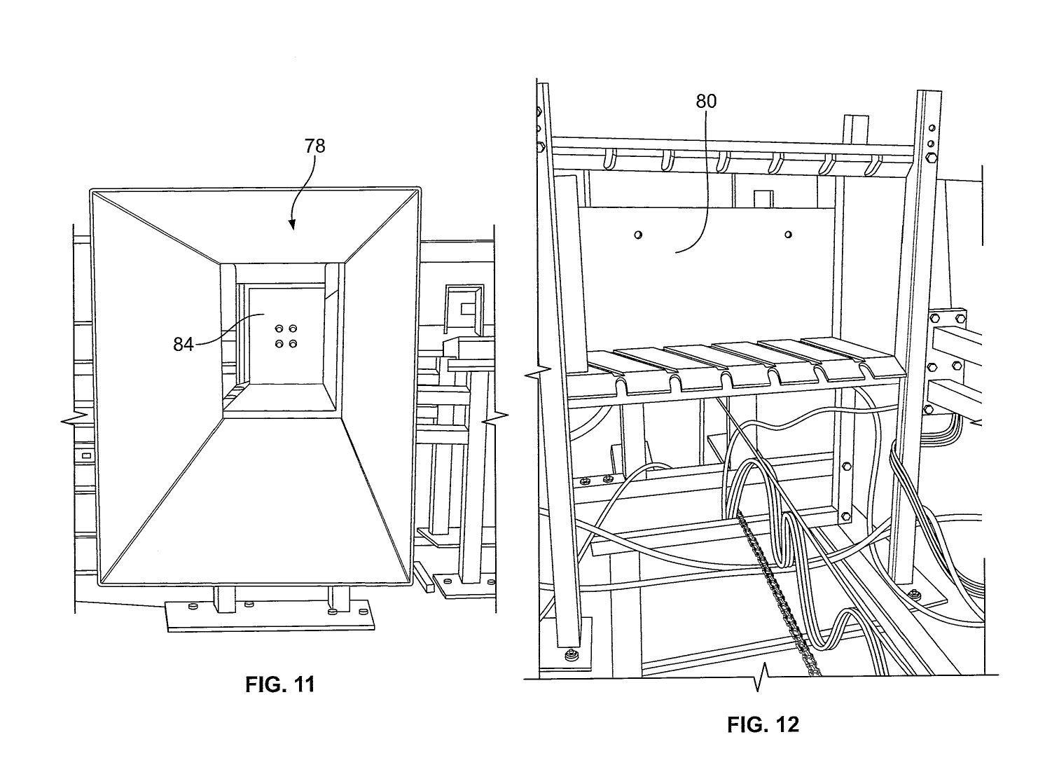

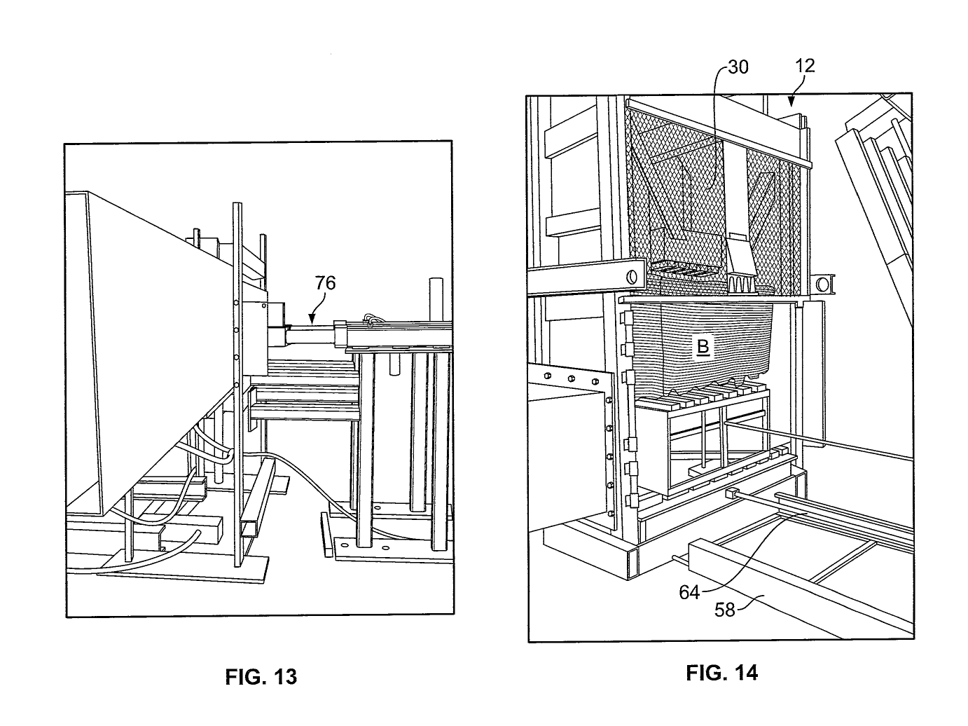

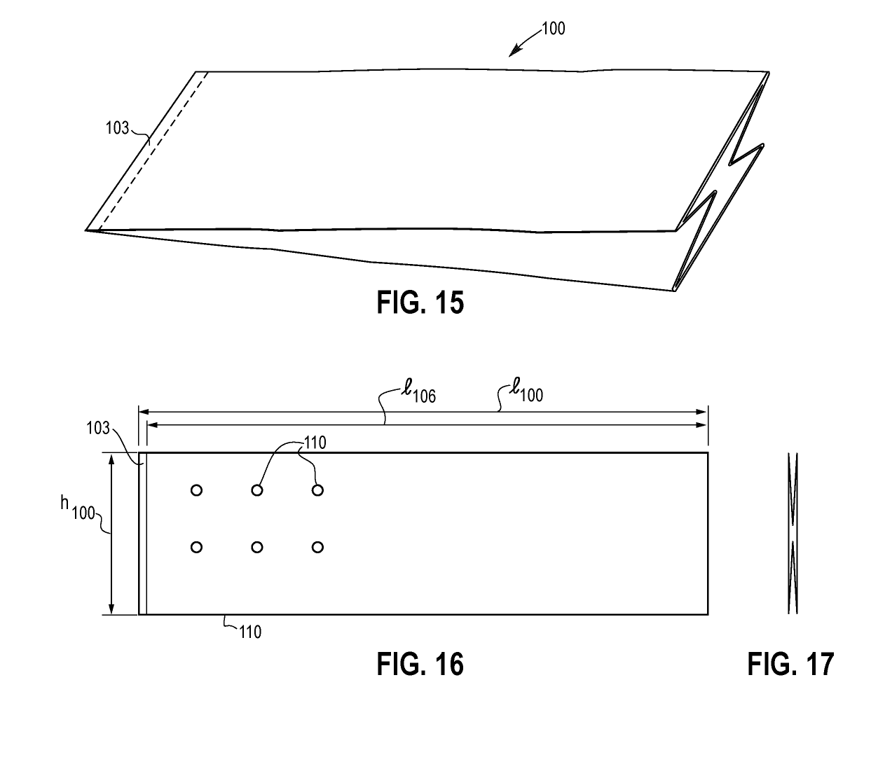

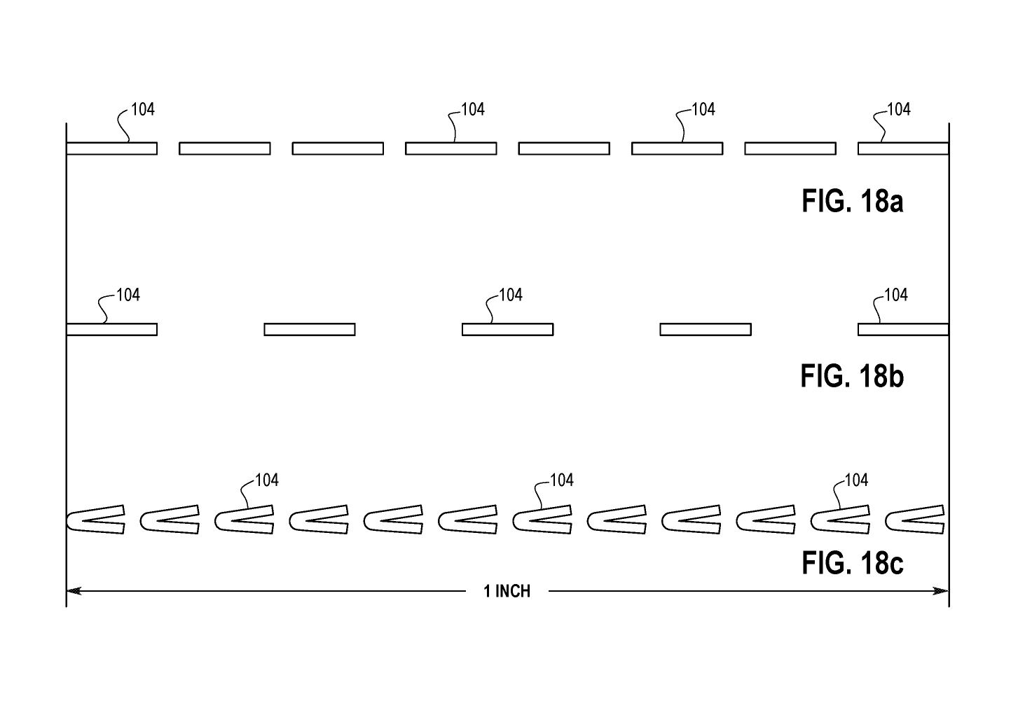

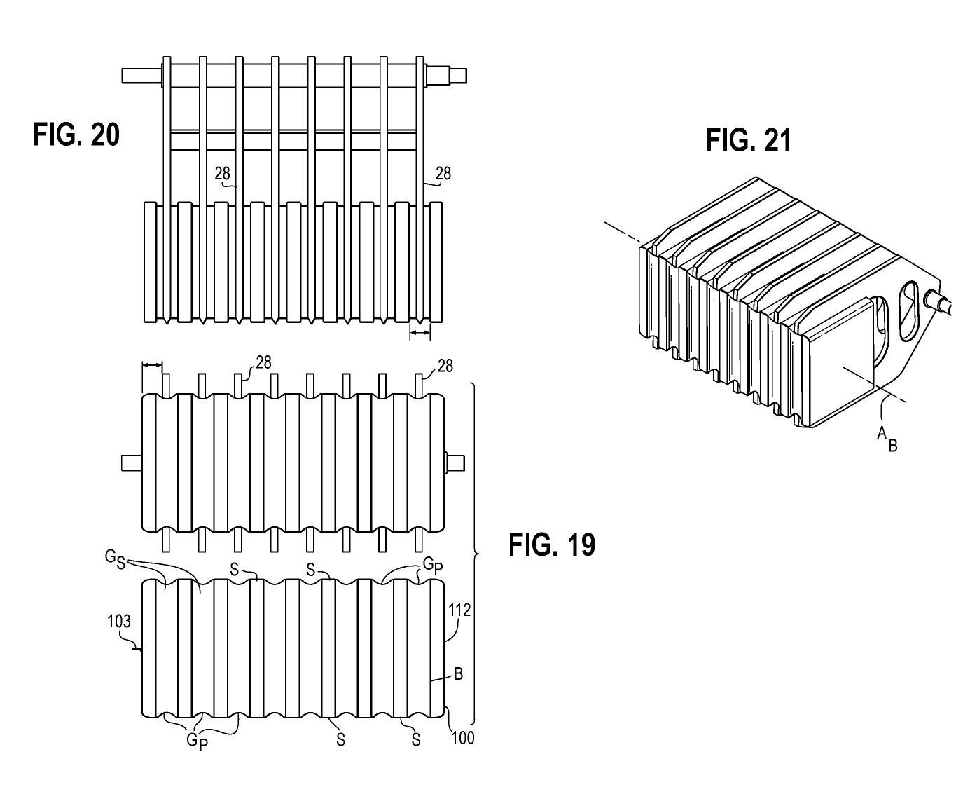

Referring now to FIGS. 1 and 2, one example embodiment of a system for containing a bale B of compressible material in a flexible bag 100 without straps of wires according to the present disclosure includes a press 12, a conveyor or cart 14, a bagging station or bagger 16 and a controller 18. The press 12 receives a quantity of compressible material and compresses the material to form a bale of compressed material. In an embodiment, the system 10 is configured to receive the compressed bale from the press 12 and cause the compressed bale B to be transferred and inserted into the bag 100. In an embodiment, during compression of the bale B, a plurality of grooves or channels G can be formed in one or more surfaces S of the bale B recessed from an outermost surface S of the bale B. The bag 100 is flexible and conforms to the shape of the compressed bale B, including the grooves or channels G, as described in further detail below.

The press 12 includes a receiver or bale box 20 and a pair of compression plates 22, 24. The bale box 20 has stationary side walls 25a,b and 27a,b that define a bale box perimeter around the compression plates 22, 24. In one embodiment, the side walls 25a,b and 27a,b of the bale box 20 define a rectangular perimeter.

In an embodiment, the compression plates 22, 24, are upper and lower compression plates. Material, such as cotton, is received in the bale box 20, and rests on, for example the lower compression plate 22. The upper compression plate or follower block 24 is positioned above the bale box 20. The bale box stationary side walls 25a,b and 27a,b contain the material as it is compressed between the upper and lower plates 22, 24.

One or both of the upper and lower compression plates 22, 24 can include a plurality of grooves or channels 26 therein. In an embodiment, the grooves or channels 26 in the upper and lower plates 24 are parallel to or coincident with one another such that they are aligned with each other. The grooves 26 can be spaced apart from each other, on one or both of the upper and lower plates 22, 24, an equal distance or at predetermined distances from one another that vary along the length of the plates 22, 24. In other words, the distances between grooves 26 along the upper and lower plates 22, 24 can be the same or they can vary. As discussed in more detail below, the grooves 26 are configured to receive the tines 28 of fork sets 38 that insert above and below the bale B.

In an embodiment, at least two of the bale box stationary side walls, for example walls 25a,b, have ribs 29 formed therein extending inwardly of the bale box 20. The ribs 29 extend along the at least two sides 25a,b in a direction parallel to the compression direction C. The ribs 29 can be formed as strips that are mounted to the walls 25a,b and extend the full length or height of the box 20. In the illustrated embodiment, the ribs 29 extend in a direction that is parallel to the compression direction C; that is, the ribs 29 extend between open ends of the bale box 20. As such, as the material is compressed between the compression plates 24, 26, it expands outwardly to the sides 25a,b and 27a,b of the bale box 20 and fills the spaces between the ribs 29.

It will be appreciated that as the material is compressed in the bale box 20 by the upper and lower plates 22, 24, grooves will be formed in the bale B by the upper and/or lower plate channels 26 and by the bale box sidewall ribs 29. The grooves formed by the compression plates or plate-formed grooves Gₚ, are formed in the direction of compression C; that is, the grooves Gₚ are formed by pushing into the material. The grooves formed by the sidewalls, or sidewall-formed grooves Gₛ are formed by the material moving outward against the stationary sidewalls 25a,b as the plates 22, 24 compress the material. The sidewall-formed grooves Gₛ are thus formed transverse to the direction of compression C. As discussed in more detail below, because the bale B, once removed from the press 12 will expand more in the direction of compression C, the sidewall-formed grooves Gₛ will remain more pronounced than the plate-formed grooves Gₚ.

As noted above, grooves G can be formed in the sides of the bale B by both the sidewalls 25a,b and the compression plates 22, 24. Regardless of where or how the grooves are formed, as the bale B expands against the bag 100, the regions of the bag 100 that overlie the recesses or grooves G conform to the shape of the recesses or grooves G which become recessed below the outermost face O of the bag 100. In this manner, any face or side of the bagged bale B that is facing or resting on the ground or floor has portions that do not make contact with the ground and so, even if the parts of the bag 100 that contact the ground are damaged, the recessed portions may remain intact.

In an embodiment, at least about 50 percent to 70 percent of the bale surface is present in the grooves Gₛ. It has been found that there is a significant increase in strength per inch of bale when at least about 50 percent to 70 percent of the bale surface is present in the grooves Gₛ. That is, by reducing the outermost surface O area that may be exposed to a surface, e.g., a floor, there is an increase in the strength of the bale as secured by the bag due to the presence of the bag 100 in the grooves G. In addition, because of the increased surface area of the bale B (the total of the outermost surface O area and the area within the grooves Gₛ), more of the bag 100 material is pulled into the grooves G to further increase the strength of the bag 100.

Referring to FIG. 14, the press 12 can include gates 30 or other personnel protection features to prevent personnel access to the press 12 when in operation.

As noted above, the system 10 includes a conveyor or cart 14, a bagger 16 and a control system or controller 18. For purposes of the present disclosure, the relative directions of side-to-side will refer to, for example, movement of the conveyor and/or cart 14 between the press 12 and bagger 16, and the directions of front-to-rear or rear-to-front will refer to, for example, movement of a bale B through the bagger 16.

In the illustrated example, the conveyor 14 is formed as a cart 32 having a load carriage 34 and a mobile base 36. The load carriage 34 includes multiple fork sets 38 mounted parallel to one another along a common shaft 40 that defines an axis A₄₀. The fork sets 38 pivot about 180 degrees about the axis A₄₀ as a single unit.

The fork sets 38 are spaced from one another a distance to cooperate with the guides 26 in the plates 22 and 24. That is, the fork sets 38 insert into the guides 26 to, as will be described below, provide upper and lower supports as the bale B is removed from the press 12.

A drive assembly 42 is operably connected to the fork sets 38 to rotate the fork sets 38 about the axis A₄₀. The drive assembly 42 includes a drive 44, such as a motor, which can drive the fork sets 38 through a chain drive 44 mounted to the shaft 40, as illustrated, a gear drive or the like. The fork sets 38 are mounted to rotate or pivot about the A₄₀ axis about 180 degrees to reorient the bale B.

A pusher or transfer plate 50 is mounted to the fork sets 38 and is configured to push a bale B that is positioned in the fork sets 38 out of the fork sets 38. Shafts 52, mounted to plate 50, are mounted for sliding engagement with linear bearings 53, which are mounted to the fork sets 38 to provide smooth, linear movement of the plate 50 and to assure that the plate 50 remains transverse to the fork sets 38 as the bale B is transferred from the fork sets 38. A support bar 54 is also mounted to the plate 50.

The load carriage 34 is mounted to the cart 14 by a pivot shaft 55 and a plurality of springs 56 extend between the load carriage 34 and the cart 14. The pivot shaft 55 allows the load carriage 34 to pivot a short distance side-to-side relative to the cart 14 and the springs 56 maintain the load carriage 34 in a relatively fixed relationship to the cart 14, but allow the load carriage 34 to pivot slightly to adjust any shifting of the bale B within the press 12 and any shifting of the plates 22 and/or 24 that may occur.

It will be appreciated that because of the extreme force (up to one million pounds) that is exerted on the bale B, the plates 22 and/or 24 may shift slightly. The pivot shaft 55 allows the load carriage 34 to pivot a short distance side-to-side and the springs 56 maintain the load carriage 34 in a relatively fixed relationship to the cart 14, but allow the load carriage 34 to pivot slightly to adjust for shifting of the bale B within the press 12.

The cart 14 is mounted to a track 58 along which it is conveyed between the press 12 and the bagger 16. The track 58 can be as long or as short as necessary to accommodate the footprint in which the system (conveyor/cart system 14 and bagger 16) and the press 12 are located. There are minimum space requirements, insofar as removing or withdrawing the bale B from the press 12 and rotating the load carriage 34 and bale B for introduction to the bagger 16.

A transfer station 66 is formed as part of the conveyor. In a present embodiment, the transfer station 66 includes a drive, such as the illustrated pair of cylinders 68 mounted upstream of the bagger 16 which cooperate with the transfer plate 50 and support bar 54 to ensure proper transfer of the bale B from the load carriage 34 to the bagger 16.

The bagger 16 includes an entrance 70, a discharge station 72, a bag mandrel 74 and may include a back-up assembly 76. The discharge station 72 includes a chute 78 into which the bale B is transferred from the load carriage 34. As such, the entrance 70 opens into a chute 78—the entrance 70 is that side facing the cart load carriage 34—to receive the bale B. The back-up assembly 76, if used, is positioned on a side opposite the entrance 70 and includes a movable wall 80 mounted to the chute 78 by a drive 82, for example, the illustrated plurality of cylinders. The wall 80 moves from the side of the chute 78 to the bale B as the bale B enters the entrance 70, to facilitate transfer of the bale B into the chute 78.

A discharge plate 84 is mounted at a rear of the discharge station 72, rearward of the entrance 70. The discharge plate 84 is driven forwardly into the chute 78 by a drive 86, for example, a cylinder. In a home position, the discharge plate 84 is rearward of the entrance 70 so as to not interfere with movement of the bale B into the chute 78. The cylinder or drive 86 for the discharge plate is a dual-acting drive so that the plate 84 can be returned to the home position following discharge of the bale B. The entrance 70 includes guides 88 that cooperate with the fork sets 38 when transferring a bale B from the load carriage 34 to the bagger 16.

The bag mandrel 74 is positioned at the front of the discharge station 72. A bag, having a sealed end, is positioned over the end of the mandrel 74. In this manner, as the bale B is pushed out of the chute 78, it engages the bag and pulls the bag onto and over the bale B.

Referring to FIGS. 26 an 27, in an embodiment, the mandrel 74 is configured with a crowned or domed profile in at least one wall. In the illustrated example, the crowned profile 75 is formed by a slight arc formed in two walls, such as the top wall 77 and bottom wall 79 of the mandrel 74. The side walls 81, 83 can be straight or planar as they extend between the top and bottom walls 77, 79. The crowned profile 75 serves to maintain the shape of the bale B, but also reduces the surface area of the bale B in contact with the mandrel walls 77, 79, 81, 83 and the forces exerted by the bale B on the mandrel 74 walls.

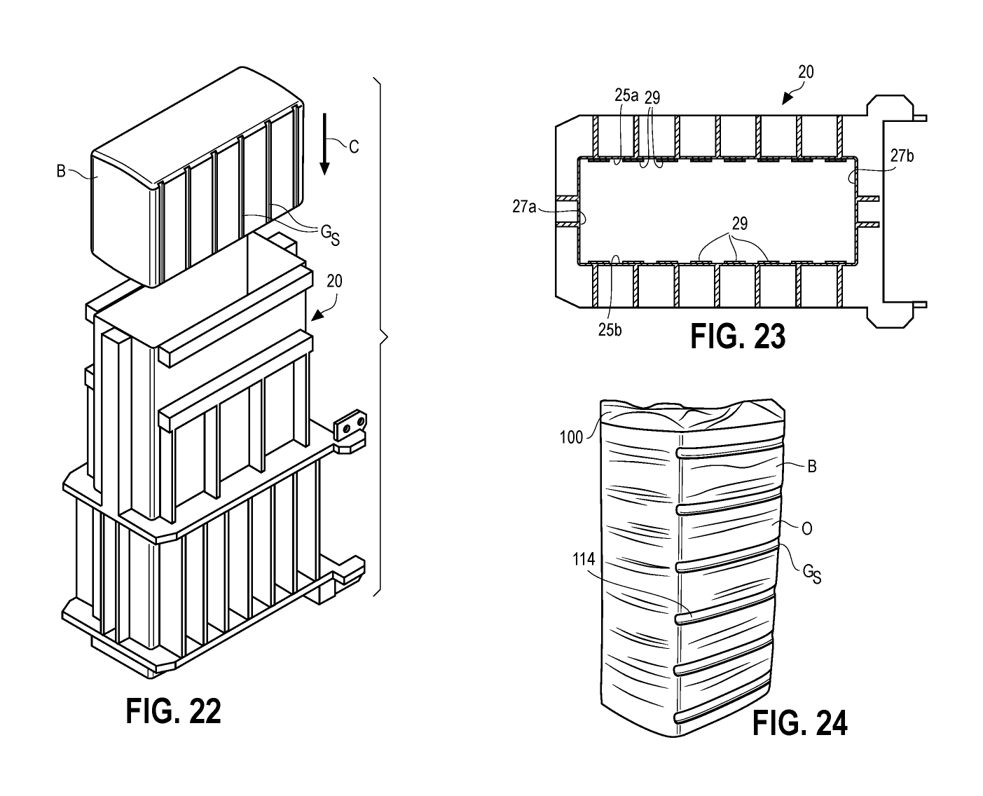

It has been observed that a compressed bale B will expand following compression, even during the time between when it is compressed and the time is it bagged. Typically, the bale B will expand in the direction of compression C. That is, referring to FIG. 22, if the bale is compressed on the top and bottom, once released from the press 12 or bale box 20, the bale B will expand upwardly and downwardly.

In fact, the bale B can expand a significant amount between the time it is removed from the press 12 and inserted into a bag 100. It has been observed that a bale B that is compressed to height of about 19 inches (the distance between the upper and lower plates 22, 24 in the press 12) can expand during transfer from the press 12 to the bagger 16 to a height of about 22 inches to 23 inches. And, once in the bag 100, the bale B can expand to a height of about 33 inches.

In an embodiment, the crowned walls 77, 79 are present in the top and bottom walls of the mandrel 74 or in the direction of compression C, which is the primary direction of expansion. The crowned walls 77, 79 reduce the hydraulic pressure exerted by the expanding bale B on the mandrel walls 77, 79, 81, 83. As such, less force is required to move the bale B through the mandrel 74 and into the bag 100.

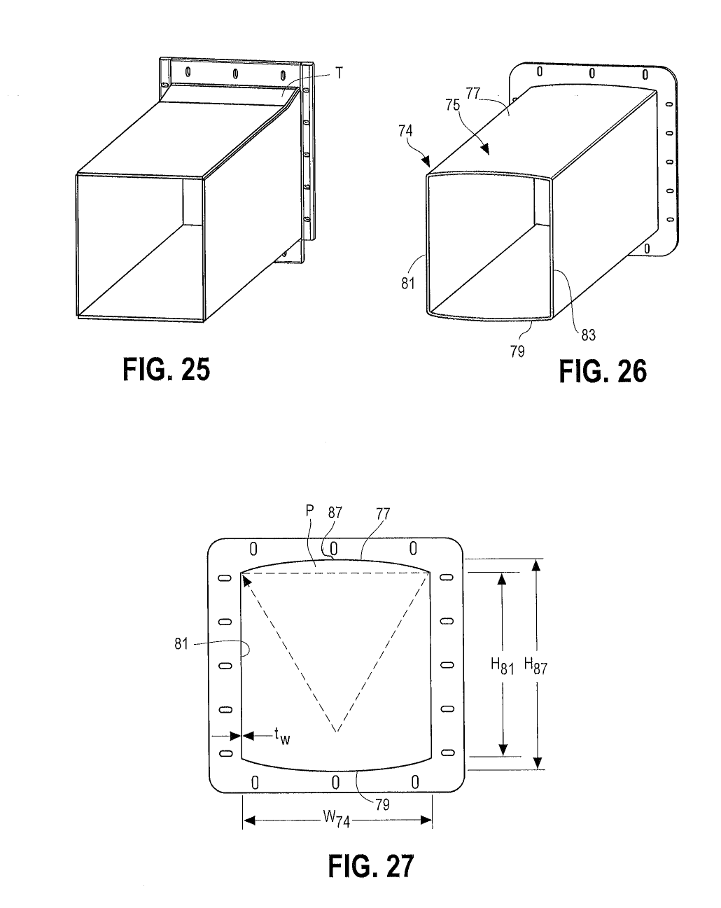

In addition, the crowned profile 75 provides an air gap P between the bale B and the crowned mandrel walls 77, 79. It has also been observed that a bale B that contacts all of the walls 77, 79, 81, 83 of the mandrel 74 may not provide adequate space for the movement of air as the bale B is conveyed through the mandrel 74. As such, air pressure may increase on a downstream end of the bale B and may decrease on the upstream end of the bale B. Such a pressure differential can further increase resistance to movement of the bale B through the mandrel 74. The crowned profile 75 reduces or eliminates the upstream/downstream pressure differential or back pressure created as the bale B moves through the mandrel 74. The crowned walls 77, 79 also eliminate the taper in the top wall of the known, straight-sided mandrel (as seen at T in FIG. 25) such that further compression of the bale in the mandrel does not occur. In addition, because the taper can be eliminated, the cross-sectional area along the length of the mandrel can be substantially constant.

In one example, the height H₈₁ of the mandrel side walls 81, 83 (which corresponds to the lowest point or end of the dome) is about 24 inches and the height H₈₇ at the peak 87 of the dome or crown 75 is about 26 inches. In this example, with a mandrel 74 width w₇₄ of about 21-¾ inches, the crowned walls 77, 79 are rolled at about a 76 inch radius (as indicated at 89 in FIG. 27).

It has also been found that using crowned walls 77, 79, the thickness t_{w} of the walls 77, 79, 81, 83 can be reduced. In an embodiment, the walls can be reduced from ⅜ inch rolled steel to ¼ inch stainless steel. Using stainless steel also prevents corrosion of the wall material and adds surface wear protection for the mandrel materials.

Referring again to FIG. 1, the controller 18 includes an operator interface station 94. The controller 18 controls the overall operation of the baler system 10. The controller 18 can also be integrated to include control of the press 12.

In a cycle, material is loaded into the press 12. When the compression or compaction cycle is complete, the press 12 is opened by, for example, lowering the lower compression plate 24, raising the bale box 20, or some similar movement or combination of movements to allow access to the compressed bale B. The cart 14 is moved toward and into the press 12. The fork sets 38, which are in a horizontal orientation, are inserted into the press upper and lower plate 22 and 24 guides 26 above and below the bale B, respectively. As noted above, in the event that the bale B shifts or that the guides 26 are slightly askew, the pivot shaft 55 and spring 56 mounting of the load carriage 34 to the cart 14 allow the load carriage 34 to pivot slightly side-to-side to align with the guides 26. Moving the cart 14 inward toward, and into engagement with the bale B urges the transfer plate 50 into the apex of the fork sets 38.

Once the cart 14 is properly positioned with the bale B captured within fork sets 38, the fork sets rotational drive 44 can be actuated to rotate the fork sets 38 and the bale B upward or downward at a slight angle to facilitate loosening the bale B from the press 12. Once the bale B is free of the press 12, the cart 14 backs away from the press 12 and begins to move toward the bagger 16. At this time, the fork sets 38 and bale B are pointed generally in the direction of the press 12. The fork sets 38 are then rotated (about 180 degrees). The fork sets 38 and bale B can be rotated as the cart 14 is moving toward the bagger 16. In the final orientation, the fork sets 38 and bale B are oriented to point toward the bagger 16 with the bale B at about the entrance 70 of the chute 78. In this position, the fork sets 38 are located between the transfer cylinders 68 and the entrance 70, and the support bar 54 is aligned (horizontally) with the transfer cylinders 68.

To accept the bale B, the back-up assembly 76, if used, is extended toward the entrance 70, and the discharge plate 84 is in a retracted or home position. The cart 14 is moved toward the bagger 16 so that the fork sets 38 align and cooperate with the entrance guides 88, and the cart is further moved forward to move the bale B into the entrance 70. When the bale is at the entrance 70, the back-up assembly wall 80 is in contact with the side of the bale B at the entrance. In this manner, the bale B is captured between the transfer plate 50 and the wall 80. The back-up assembly 76, which as noted above may be used, can be used if, for example, there is more fiber on one side of the bale B than on the other side of the bale B. Thus, when the bale B is captured between the transfer plate 50 and the back-up assembly 76, the back-up assembly 76 supports bale B transfer from the fork sets 38 and also prevents loosening of the bale (e.g., the bale B is retained in the compressed state).

The transfer cylinders 68 are then actuated which pushes the transfer plate 50, which in turn pushes the bale B in a transfer direction from the fork sets 38 into the entrance 70. It will be appreciated that the shafts 52 maintain the plate 50 flat against the side of the bale B, and do not allow the plate to skew, as the bale B is pushed into the entrance 70. Pushing the bale B into the entrance 70 also pushes the wall 80 back to a retracted position.

Once the bale B is in the chute 78, the discharge plate cylinder 86 is actuated to push the bale B from the entrance 70 along or through the chute 78 toward the bag mandrel 74 in a bagging or containerizing direction.

It is contemplated that a bale B will be present in the mandrel 74 as a subsequent bale is introduced into the entrance 70. As the bale B in entrance 70 is urged toward the discharge end 90 of the mandrel 74, the prior bale (in the mandrel 74) is forced out of the mandrel 74 and is captured in a bag 100 at the final discharge 92.

The bag 100 is flexible and conforms to the shape of the compressed bale B. In various embodiments, the bag 100 is made of a suitable high strength material or combination of materials such as polyethylene terephthalate (PET), polypropylene, polyethylene, or the like. It is anticipated that bags 100 can be manufactured from recycled materials, for example, recycled PET, which provides the necessary strength. In an embodiment, the bag 100 is formed by weaving or looming the polymeric strands or tapes to form the woven material. In an embodiment, a bag 100 may be formed from a material of woven strands or tapes of polyethylene terephthalate (PET). Those skilled in the art will recognize that such a woven material can be formed from any suitable material and, if woven from tapes, may be formed having any suitable tape density. In various embodiments, the bag 100 of the present disclosure may include one or more ventilation holes or openings 110 to permit ventilation for the compressed load to, for example, reduce condensation in the wrapped load and to permit air circulation around the load. An end of the bag may include a seal 103

When the bale B is introduced into the bag 100, the bale B will expand. It has been observed that the bale B will expand to a greater extent in the direction of compression C. Viewed another way, the plate-formed grooves Gₚ will expand more than the sidewall-formed grooves Gₓ, because the plate-formed grooves Gₚ are formed in the direction of compression C of the bale B. As such, the sidewall-formed grooves Gₛ will remain more pronounced and will better retain their profile than the plate-formed grooves Gₚ. And, when the bale B is introduced into the bag 100, the bag 100 will conform to all of the grooves G, including the more pronounced sidewall-formed grooves G.

Advantageously, the portions of the bag 100 overlying any face or side of the bagged bale B that is facing or resting on the ground (or floor) has portions that do not make contact with the ground. Thus, even if the bag 100 on the surface of the bale B is abraded or torn, the regions of the bag within the grooves G will maintain the bale B in a compressed state and will maintain the integrity of the bale. For example, if the parts of the bag 100 that contact the ground are damaged (such as when the bale B is moved around the floor of a warehouse, or loaded and unloaded from a truck and the face of the bag 100 is abraded), the recessed portions of the bag 100 which conform to the channels or grooves G may remain intact to maintain the bale in a compressed and contained state.

In an embodiment a method for compressing, containing, and protecting a compressible material, includes receiving a quantity of the compressible material in a press 12. The material is compressed, forming a plurality of grooves G in one or more sides of the bale B. In an embodiment, the grooves G are formed in opposing sides of the bale B. The grooves can be plate-formed grooves Gₚ, for example, formed in the top and/or bottom faces of the bale B engaged by the upper and/or lower compression plates 22, 24, the grooves can be sidewall-formed grooves Gₛ formed in the sides of the bale B engaged by the bale box sidewalls 25a,b, or the grooves G can be formed in a combination of the sides (including the top and bottom) of the bale B. In an embodiment, sidewall-formed grooves Gₛ are formed in at least two sides of the bale B.

In an embodiment, the method includes compressing the bale of material at a first location (at the press 12) and transferring the compressed bale B, in a transfer direction to a second, different location (a bagging or containerizing location 16) for bagging. In some embodiments, while being transferred to the bagging location 16, the bale B is retained in the compressed state. The method includes conveying the compressed bale through a mandrel having at least two crowned walls and into a bag. In a method, bagging or containerizing may be carried out in a different direction (a bagging or containerizing direction) different from (e.g., transverse to) the transfer direction.

As noted above, the baling system 10 enables compressing, transferring and containing a compressible material such as cotton, without the need for straps, wires or the like. In an embodiment of a method for transferring and containing a bale of compressible material, the bale is transferred from a press to an entrance of a bagger. The bale is moved from the entrance of the bagger to a mandrel. The mandrel has at least two walls having a crowned profile so as to define an air space between the bale of compressible material and the at least two walls. The air space has an arcuate profile. The bale is then urged out of the mandrel and into a bag positioned on an end of the mandrel. The crowned profile relieves back pressure created by the bale as it moves through the mandrel 74.

It will be appreciated that the recessed or groove-conforming portions 114 of the bag 100, that is the portions of the bag 100 that conform to the grooves G, facilitate maintaining the integrity of the bale B even if the outermost 0 or facial portions of the bag 100 are damaged, such as by abrasion.

It will also be appreciated by those skilled in the art that the relative directional terms such as sides, upper, lower, rearward, forward and the like are for explanatory purposes only and are not intended to limit the scope of the disclosure.

All patents or patent applications referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within the scope of the claims.

What is claimed is:

1. A system for transferring and containing a bale of compressible material comprising:
a conveyor;
a transfer device to transfer the bale of compressible material from the conveyor; and
a bagger, the bagger including an entrance, a discharge station and a bag mandrel, the mandrel having a plurality of walls, at least one of the walls having a crowned profile,
wherein the bale is received in the entrance from the transfer device and is discharged from the bagger by the discharge station into a bag positioned on the mandrel.

2. The system of claim 1 wherein the mandrel includes four wall and wherein the at least two walls have a crowned profile.

3. The system of claim 2 wherein the mandrel includes four wall and wherein the at least two walls oppose one another.

4. The system of claim 3 wherein the at least two walls are a top wall and a bottom wall.

5. The system of claim 4 wherein sides extending between the top wall and the bottom wall are planar.

6. The system of claim 1 wherein a cross-sectional area of the mandrel is substantially constant along a length thereof.

7. The system of claim 1 wherein the crowned profile is formed by a substantially constant radius.

8. The system of claim 4 wherein a distance measured at a peak-to-peak location of the crowned profile between the top wall and the bottom wall is at least about 108 percent of a least most distance measured between the top wall and the bottom wall.

9. A bag mandrel for use on a device for compressing and containing a bale of compressible material, comprising:
four walls defining an open discharge region for conveyance of the bale, two of the walls opposing one another having a crowned profile.

10. The bag mandrel of claim 9 wherein the walls extending between the crowned profile walls are planar.

11. The bag mandrel of claim 9 wherein a cross-sectional area of the mandrel is substantially constant along a length thereof.

12. The bag mandrel of claim 9 wherein the crowned profile is formed by a substantially constant radius.

13. The bag mandrel of claim 9 wherein a distance measured at a peak-to-peak location of the crowned profile between the top wall and the bottom wall is at least about 108 percent of a least most distance measured between the top wall and the bottom wall.

14. A method for transferring and containing a bale of compressible material comprising:
transferring the bale of compressible material to an entrance of a bagger;
moving the bale of compressible from the entrance of the bagger to a mandrel, the mandrel having at least one wall having a crowned profile so as to define an air space between the bale of compressible material and the at least one wall, the air space having an arcuate profile; and
urging the bale of compressible material out of the mandrel and into a bag positioned on an end of the mandrel.

15. The method of claim 14 wherein at least two walls have a crowned profile.

16. The method of claim 15 wherein the at least two walls are a top wall and a bottom wall.

17. The method of claim 14 wherein the top wall has a crowned profile and wherein the bale is urged through the mandrel and a topmost center of the bale remains spaced from a center of the top wall.
